(19) United States
(12) Patent Application Publication
(10) Pub. No.: US 2011/0131612 A1
(43) Pub. Date: Jun. 2, 2011

(54) METHOD FOR PROVIDING A USER WITH A REMOTE CONTROLLER LEARNING SERVICE IN AN ELECTRONIC DEVICE, AND ASSOCIATED ELECTRONIC DEVICE

(76) Inventors: Xu-tong Hu, Hefei City (CN); Min Li, Anqin City (CN)

(21) Appl. No.: 12/690,039

(22) Filed: Jan. 19, 2010

(30) Foreign Application Priority Data
Nov. 27, 2009 (CN) 200910250407.9

(51) Int. Cl. H04N 5/445

(52) U.S. Cl. 725/60

(57) ABSTRACT

A method for providing a user with a remote controller learning service in an electronic device includes: providing the user with guiding information through a user interface to ask for pressing at least one key of a remote controller of a device, other than the electronic device, wherein the at least one key is utilized for representing a specific operation of the electronic device; and associating the at least one key of the remote controller with the specific operation of the electronic device by storing learning information of the at least one key. An associated electronic device includes a controller arranged to provide the user with the remote controller learning service. In particular, the controller provides the user with the guiding information through the user interface to ask for pressing the at least one key of the remote controller of the device, other than the electronic device.

### BACKGROUND

The present invention relates to remote control facility management, and more particularly, to a method for providing a user with a remote controller learning service in an electronic device, and to an associated electronic device.

Multi-channel broadcasting program systems such as digital television (TV) receivers have become popular since there are many attractive characteristics such as better image quality and more information for respective programs of different channels. Typically, when a user who owns an analog TV comprising a set of audio/video input terminals wants to set up a digital TV system without disposing of the analog TV, the user may simply install a digital TV receiver set-top box (STB) by electrically connecting a set of audio/video output terminals of the digital TV receiver STB to the set of audio/video input terminals of the analog TV. In addition, the user may own a digital versatile disc (DVD) player comprising a set of audio/video output terminals electrically connected to another set of audio/video input terminals of the analog TV. Additionally, the user may further own an audio playback system with the analog TV, the digital TV receiver STB, and/or the DVD player being installed as audio source(s) of the audio playback system.

As a result of owning the whole composite system described above, the user may have a plurality of remote controllers respectively corresponding to the analog TV, the digital TV receiver STB, the DVD player, and the audio playback system, causing the user tending to feel confused. In a situation where the audio playback system comprises a plurality of sub-systems, the total number of remote controllers typically increases. Please note that the user may have some more remote controllers respectively corresponding to some other electronic devices.

The conventional electronic devices implemented according to the related art (e.g. the analog TV, the digital TV receiver STB, the DVD player, and the audio playback system mentioned above) can hardly serve the user well when all the remote controllers are put together since the user may wonder whether to pick up one remote controller or another. Such an increased number of remote controllers would become a nightmare. Thus, a novel method and associated electronic devices are required for solving the related art problem.

### SUMMARY

It is therefore an objective of the claimed invention to provide a method for providing a user with a remote controller learning service in an electronic device, and to provide an associated electronic device, in order to solve the above-mentioned problem.

An exemplary embodiment of a method for providing a user with a remote controller learning service in an electronic device comprises: providing the user with guiding information through a user interface to ask for pressing at least one key of a remote controller of a device, other than the electronic device, wherein the at least one key is utilized for representing a specific operation of the electronic device; and associating the at least one key of the remote controller with the specific operation of the electronic device by storing learning information of the at least one key.

An exemplary embodiment of an associated electronic device comprises a controller arranged to provide a user with a remote controller learning service. In addition, the controller provides the user with guiding information through a user interface to ask for pressing at least one key of a remote controller of a device, other than the electronic device, wherein the at least one key is utilized for representing a specific operation of the electronic device. Additionally, the controller associates the at least one key of the remote controller with the specific operation of the electronic device by storing learning information of the at least one key.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an electronic device capable of providing a user with a remote controller learning service according to a first embodiment of the present invention.

FIG. 2 is a flowchart of a method for providing a user with a remote controller learning service in an electronic device according to one embodiment of the present invention.

FIG. 3 is a diagram of an electronic device capable of providing a user with a remote controller learning service according to a second embodiment of the present invention.

FIG. 4 is a diagram of an electronic device capable of providing a user with a remote controller learning service according to a third embodiment of the present invention.

FIG. 5 is a diagram of an electronic device capable of providing a user with a remote controller learning service according to a fourth embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

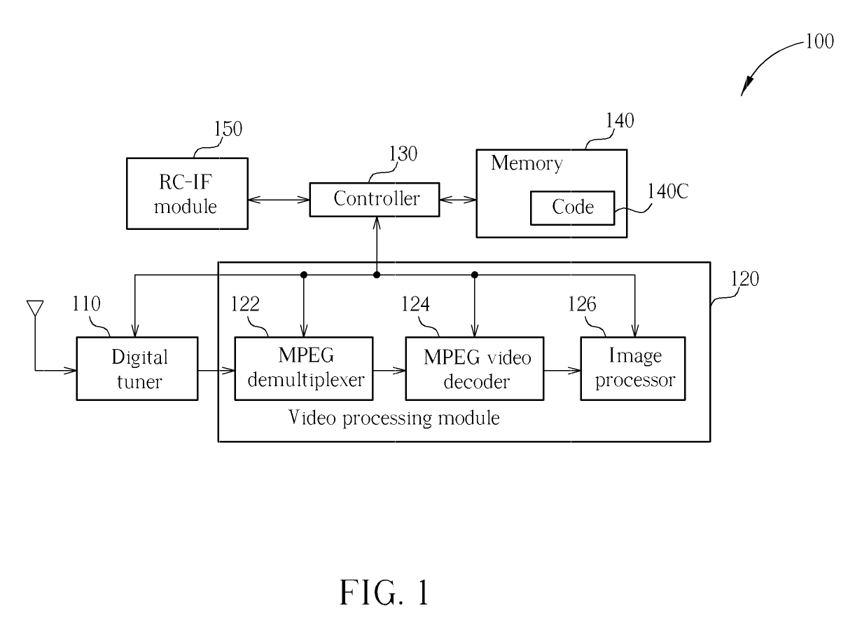

Please refer to FIG. 1. FIG. 1 is a diagram of an electronic device capable of providing a user with a remote controller learning service according to a first embodiment of the present invention, where the electronic device of this embodiment is a multi-channel broadcasting program receiver 100. The multi-channel broadcasting program receiver 100 comprises a tuner such as a digital tuner 110, a video processing module 120, a controller 130, a memory 140, and a remote controller interface module 150 (labeled “RC-IF module” in FIG. 1) such as an infrared (IR) wireless communication module. This is for illustrative purposes only, and is not meant to be a limitation of the present invention. According to different variations of the first embodiment, the remote controller interface module 150 can be other kinds of wireless communication modules. In particular, the remote controller interface module 150 of this embodiment can be implemented with an IR interface module comprising an IR sensor and an interface circuit.

In this embodiment, the digital tuner 110 is arranged to select one of a plurality of channels, and the video processing module 120 is arranged to decode according to selection of the digital tuner 110. In addition, the controller 130 is arranged to control operations of the aforementioned electronic device such as the multi-channel broadcasting program receiver 100, and is further arranged to provide the user with the remote controller learning service mentioned above. In this embodiment, the controller 130 is a micro control unit (MCU) executing program code 140C (simply labeled “Code” in FIG. 1) stored in the memory 140. According to a variation of this embodiment, the controller 130 can be a hardware controller with the program code 140C embedded therein. The program code to be executed by the controller 130, such as the program code 140C, can be stored in a memory such as the memory 140 or embedded in the controller 130 according to different variations of this embodiment.

According to the first embodiment, the video processing module 120 comprises an MPEG demultiplexer 122, an MPEG video decoder 124 and an image processor 126. The MPEG demultiplexer 122 is arranged to demultiplex video content and audio content of a program on the channel selected by the digital tuner 110. In addition, the MPEG video decoder 124 is arranged to decode the video content demultiplexed by the MPEG demultiplexer 122, and more particularly, to perform MPEG-decoding on the video content. Additionally, the image processor 126 may further perform image processing on the decoded video content to be displayed. Please note that whether an on screen display (OSD) processing circuit is utilized for processing the video content to be displayed depends on different variations of this embodiment. In addition, according to different variations of this embodiment, a display module can be integrated into the multi-channel broadcasting program receiver 100.

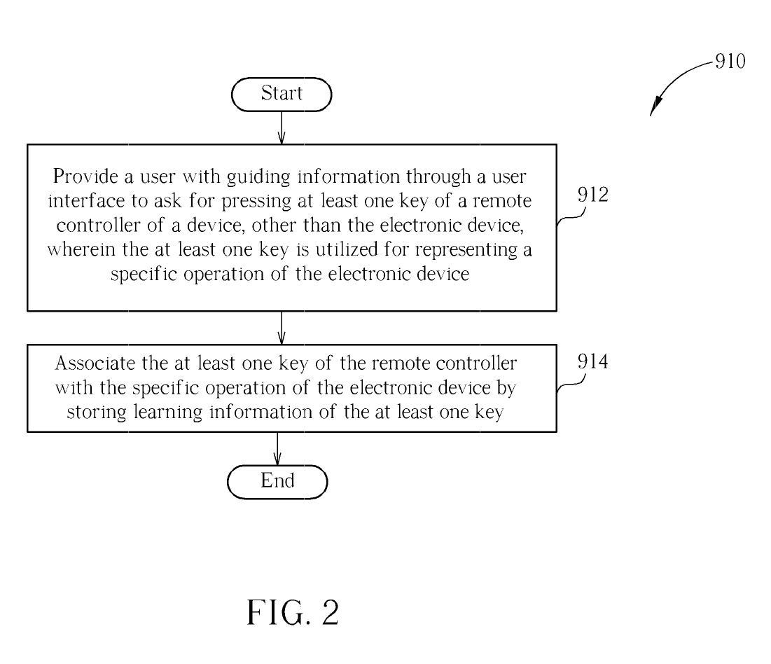

FIG. 2 is a flowchart of a method 910 for providing a user with a remote controller learning service in an electronic device according to one embodiment of the present invention. The method 910 can be applied to the aforementioned electronic device such as the multi-channel broadcasting program receiver 100 shown in FIG. 1, and can be implemented by utilizing the aforementioned electronic device such as the multi-channel broadcasting program receiver 100. The method 910 is described according to the first embodiment as follows.

In Step 912, the controller 130 executing the program code 140C provides the user with guiding information through a user interface to ask for pressing at least one key of a remote controller of a device (e.g. the analog TV, the DVD player, or the audio playback system mentioned above), other than the electronic device, where the at least one key is utilized for representing a specific operation of the electronic device. For example, in a situation where the guiding information comprises video guiding information, the user interface may comprise a display device (e.g. a liquid crystal display (LCD) monitor or a projector) electrically connected to a video output terminal of the multi-channel broadcasting program receiver 100. In another example, in a situation where the guiding information comprises audio guiding information, the user interface may comprise a speaker coupled or electrically connected to at least one audio output terminal of the multi-channel broadcasting program receiver 100. In another example, in a situation where the guiding information comprises audio guiding information, the user interface may comprise an earphone coupled or electrically connected to at least one audio output terminal of the multi-channel broadcasting program receiver 100.

In Step 914, the controller 130 executing the program code 140C associates the at least one key of the remote controller with the specific operation of the electronic device by storing learning information of the at least one key. In this embodiment, the controller 130 executing the program code 140C receives at least one remote control code from the remote controller through the remote controller interface module 150 when the at least one key is pressed, where the learning information of the at least one key corresponds to the at least one remote control code. In particular, in a situation where the at least one key comprises a plurality of keys, the at least one remote control code comprises a plurality of remote control codes corresponding to the plurality of keys.

According to this embodiment, the controller 130 executing the program code 140C utilizes a memory such as the memory 140 to store the learning information of the at least one key. More particularly, the learning information of the at least one key comprises the at least one remote control code. This is for illustrative purposes only, and is not meant to be a limitation of the present invention. According to some variations of this embodiment, the learning information of the at least one key represents the at least one remote control code. For example, the learning information of the at least one key may comprise a representative value of the at least one remote control code, and the controller 130 executing the program code 140C can obtain the at least one remote control code according to the representative value by utilizing a mapping table or by predetermined calculations.

In addition, the controller 130 executing the program code 140C can store the learning information of different keys and/or different sets of keys corresponding to a plurality of operations of the electronic device. More specifically, in different iterations of the remote controller learning service, the controller 130 executing the program code 140C can learn different keys and/or different sets of keys for remotely controlling the plurality of operations, respectively.

For example, in a first iteration of the remote controller learning service, the specific operation mentioned in Step 912 may represent decreasing volume, where the guiding information may comprise a message such as “Press the key that represents decreasing volume.” In a second iteration of the remote controller learning service, the specific operation mentioned in Step 912 may represent increasing volume, where the guiding information may comprise a message such as “Press the key that represents increasing volume.” In addition, in a third iteration of the remote controller learning service, the specific operation mentioned in Step 912 may represent switching to a previous channel, where the guiding information may comprise a message such as “Press the key that represents switching to the previous channel.” Additionally, in a fourth iteration of the remote controller learning service, the specific operation mentioned in Step 912 may represent switching to a next channel, where the guiding information may comprise a message such as “Press the key that represents switching to the next channel.” And in a subsequent iteration of the remote controller learning service, the specific operation mentioned in Step 912 may represent another operation. Please note that, in a situation where the guiding information comprises video guiding information, the messages mentioned above can be implemented with video messages. In a situation where the guiding information comprises audio guiding information, the messages mentioned above can be implemented with audio messages.

As a result, when the user utilizes the remote controller of the aforementioned device (e.g. the analog TV, the DVD player, or the audio playback system mentioned above), other than the electronic device, to remotely control the electronic device such as the multi-channel broadcasting program receiver 100, the electronic device can perform one of the operations as desired by the user.

In this embodiment, the controller 130 executing the program code 140C can further provide the user with a guessing mechanism for guessing which remote controller is used by the user, so the controller 130 will not confuse a remote control code of the remote controller of the aforementioned device (e.g. the analog TV, the DVD player, or the audio playback system mentioned above) with that of another remote controller (e.g. the remote controller of the electronic device, or the remote controller of another device). In particular, the guessing mechanism detects a current status of the electronic device in order to determine which remote controller is the most possible remote controller among others. This is for illustrative purposes only, and is not meant to be a limitation of the present invention. According to some variations of this embodiment, the controller 130 executing the program code 140C can further provide the user with a locking mechanism for locking the remote controller or another remote controller as an active remote controller. Therefore, based upon user settings or default settings of the electronic device, the controller 130 executing the program code 140C can temporarily enable only one remote controller (i.e. the active remote controller) and disable the other remote controllers to prevent confusion.

According to this embodiment, in a situation where the at least one key comprises a plurality of keys, the controller 130 executing the program code 140C associates the plurality of keys of the remote controller with the specific operation of the electronic device by storing the learning information of the plurality of keys. This is for illustrative purposes only, and is not meant to be a limitation of the present invention. According to a variation of this embodiment, in a situation where the at least one key comprises a plurality of keys, the controller 130 executing the program code 140C associates the plurality of keys of the remote controller with the specific operation of the electronic device by storing the learning information of an order of the keys (e.g. the order in which the keys are pressed).

According to another variation of this embodiment, in a situation where the at least one key comprises a plurality of keys, the controller 130 executing the program code 140C associates the plurality of keys of the remote controller with the specific operation of the electronic device by storing the learning information of the plurality of keys and an order of the keys (e.g. the order in which the keys are pressed).

According to another variation of this embodiment, the controller 130 executing the program code 140C associates a single key of the remote controller with the specific operation of the electronic device by storing the learning information of the single key. According to this variation, in one iteration of the remote controller learning service, the controller 130 executing the program code 140C associates only the first key pressed by the user with the specific operation of the electronic device in Step 914 in a situation where the user presses a plurality of keys. Similar descriptions for this variation are not repeated in detail.

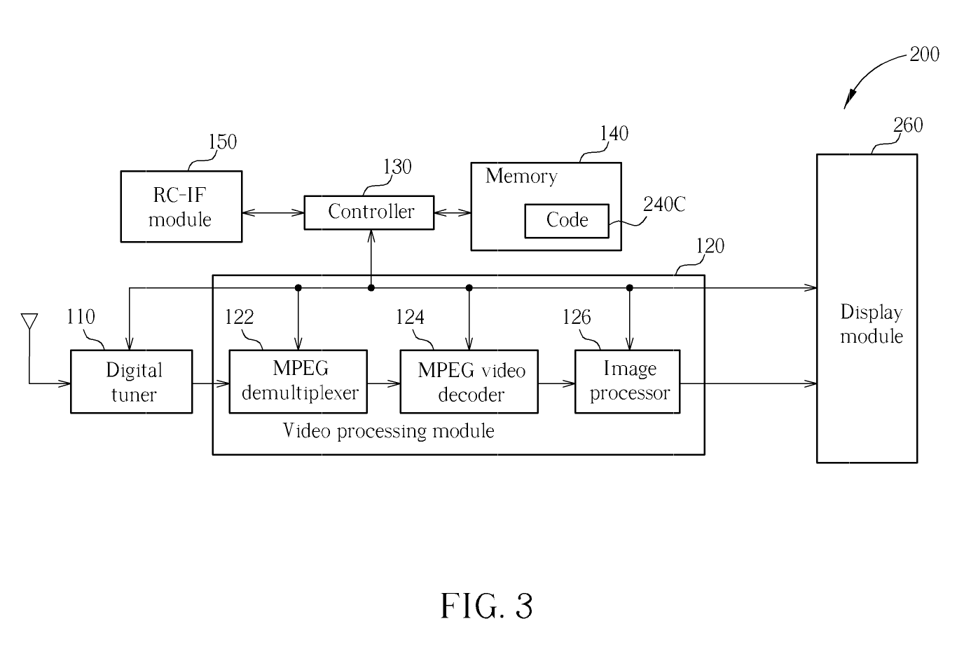

FIG. 3 is a diagram of an electronic device capable of providing a user with a remote controller learning service according to a second embodiment of the present invention, where the electronic device of this embodiment is a multi-channel broadcasting program receiver 200 (e.g. an LCD TV). This embodiment is a variation of the first embodiment. As shown in FIG. 3, the multi-channel broadcasting program receiver 200 comprises the components shown in FIG. 1 and further comprises a display module 260 (e.g. an LCD panel) arranged to display the decoded video content, where the program code 140C is replaced with the program code 240C (simply labeled “Code” in FIG. 3) in response to the change of the architecture.

For example, in a situation where the guiding information comprises video guiding information, the user interface mentioned in Step 912 may comprise the display module 260. In another example, in a situation where the guiding information comprises audio guiding information, the user interface mentioned in Step 912 may comprise a speaker (not shown) of the multi-channel broadcasting program receiver 200. In another example, in a situation where the guiding information comprises audio guiding information, the user interface may comprise an earphone coupled or electrically connected to at least one audio output terminal of the multi-channel broadcasting program receiver 200. Similar descriptions for this embodiment are not repeated in detail.

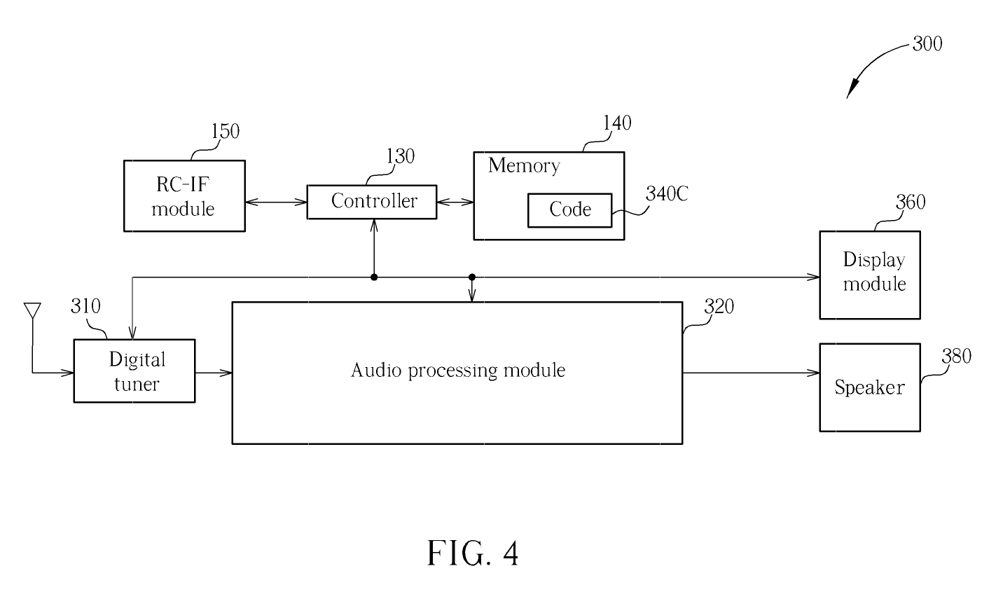

FIG. 4 is a diagram of an electronic device capable of providing a user with a remote controller learning service according to a third embodiment of the present invention, where the electronic device of this embodiment is an audio playback system 300. This embodiment is a variation of the second embodiment. The digital tuner 110 and the video processing module 120 mentioned above are respectively replaced by a digital tuner 310 and an audio processing module 320 that outputs audio signals to at least one speaker 380, as shown in FIG. 4. In addition, the digital tuner 310 is arranged to select one of a plurality of channels, and more particularly, audio channels. Additionally, the audio processing module 320 is arranged to perform audio processing on signals of the channel selected by the digital tuner 310, and is further arranged to perform audio processing on signals received from some other audio sources (not shown). Please note that the program code 140C is replaced with the program code 340C (simply labeled “Code” in FIG. 4) in response to the change of the architecture.

In this variation, the display module 360 is utilized for displaying information sent from the controller 130, such as the video guiding information mentioned above. In addition, the speaker 380 can be utilized for outputting audio information sent from the controller 130, such as the audio guiding information mentioned above. Additionally, in a first iteration of the remote controller learning service, the specific operation mentioned in Step 912 may represent decreasing volume, where the guiding information may comprise a message such as “Press the key that represents decreasing volume.” In a second iteration of the remote controller learning service, the specific operation mentioned in Step 912 may represent increasing volume, where the guiding information may comprise a message such as “Press the key that represents increasing volume.” In a subsequent iteration of the remote controller learning service, the specific operation mentioned in Step 912 may represent another operation. Similar descriptions for this variation are not repeated in detail.

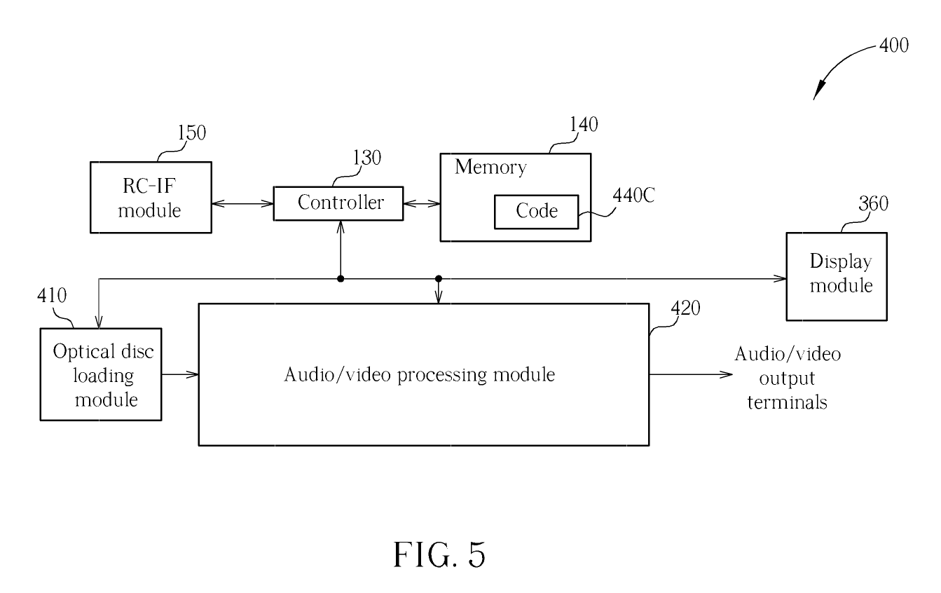

FIG. 5 is a diagram of an electronic device capable of providing a user with a remote controller learning service according to a fourth embodiment of the present invention, where the electronic device of this embodiment is an optical disc player 400. This embodiment is a variation of the second embodiment. The digital tuner 110 and the video processing module 120 mentioned above are respectively replaced by an optical disc loading module 410 and an audio/video processing module 420 that outputs audio/video signals through audio/video output terminals, as shown in FIG. 5. In addition, the optical disc loading module 410 is arranged to load and access an optical disc, such as a digital versatile disc (DVD) or a compact disc (CD). Additionally, the audio/video processing module 420 is arranged to perform audio/video processing on signals received from the optical disc loading module 410. Please note that the program code 140C is replaced with the program code 440C (simply labeled “Code” in FIG. 5) in response to the change of the architecture.

In this variation, the display module 360 can be utilized for displaying information sent from the controller 130, such as the video guiding information mentioned above. In addition, the audio/video output terminals of the optical disc player 400 can be utilized for outputting the guiding information, such as the video guiding information mentioned above and the audio guiding information mentioned above. Additionally, in a first iteration of the remote controller learning service, the specific operation mentioned in Step 912 may represent play, where the guiding information may comprise a message such as “Press the key that represents Play.” In a second iteration of the remote controller learning service, the specific operation mentioned in Step 912 may represent stop, where the guiding information may comprise a message such as “Press the key that represents Stop.” In a third iteration of the remote controller learning service, the specific operation mentioned in Step 912 may represent switching to a previous track, where the guiding information may comprise a message such as “Press the key that represents switching to the previous track.” In a fourth iteration of the remote controller learning service, the specific operation mentioned in Step 912 may represent switching to a next track, where the guiding information may comprise a message such as “Press the key that represents switching to the next track.” In a subsequent iteration of the remote controller learning service, the specific operation mentioned in Step 912 may represent another operation. Similar descriptions for this variation are not repeated in detail.

According to different variations of the embodiments disclosed above, the method 910 shown in FIG. 2 can be applied to various kinds of electronic devices having remote control facility. For example, the electronic devices that can be implemented by utilizing the method 910 shown in FIG. 2 may comprise air conditioners, refrigerators, projectors, audio playback systems, home theater systems, illumination systems, and so on.

In contrast to the related art, the present invention method and the associated electronic device can serve the user well by providing the user with the remote controller learning service. In a situation where a lot of remote controllers are put together, they will not become a nightmare. After utilizing the remote controller learning service, the user can simply pick up the most favorite remote controller to remotely control the electronic device.

It is another advantage of the present invention that the present invention method and the associated electronic device can significantly save the user's time. After utilizing the remote controller learning service, the user can simply pick up any remote controller to remotely control the electronic device.

Those skilled in the art will readily observe that numerous modifications and alterations of the device and method may be made while retaining the teachings of the invention.

What is claimed is:

1. A method for providing a user with a remote controller learning service in an electronic device, the method comprising:
providing the user with guiding information through a user interface to ask for pressing at least one key of a remote controller of a device, other than the electronic device, wherein the at least one key is utilized for representing a specific operation of the electronic device; and
associating the at least one key of the remote controller with the specific operation of the electronic device by storing learning information of the at least one key.

2. The method of claim 1, further comprising:
receiving at least one remote control code from the remote controller through a remote controller interface module of the electronic device when the at least one key is pressed;
wherein the learning information of the at least one key corresponds to the at least one remote control code.

3. The method of claim 2, wherein the at least one key comprises a plurality of keys; and the at least one remote control code comprises a plurality of remote control codes corresponding to the plurality of keys.

4. The method of claim 1, wherein the at least one key comprises a plurality of keys; and the step of associating the at least one key of the remote controller with the specific operation of the electronic device by storing the learning information of the at least one key further comprises:
associating the plurality of keys of the remote controller with the specific operation of the electronic device by storing the learning information of the plurality of keys.

5. The method of claim 1, wherein the at least one key comprises a plurality of keys; and the step of associating the at least one key of the remote controller with the specific operation of the electronic device by storing the learning information of the at least one key further comprises:
associating the plurality of keys of the remote controller with the specific operation of the electronic device by storing the learning information of an order of the keys.

6. The method of claim 1, further comprising:
providing the user with a guessing mechanism for guessing which remote controller is used by the user, wherein the guessing mechanism detects a current status of the electronic device in order to determine which remote controller is a most possible remote controller among others.

7. The method of claim 1, further comprising:
providing the user with a locking mechanism for locking the remote controller or another remote controller as an active remote controller.

8. The method of claim 1, wherein the electronic device is a multi-channel broadcasting program receiver; and the specific operation represents decreasing volume or increasing volume, or represents switching to a previous channel or switching to a next channel.

9. The method of claim 1, wherein the electronic device is an audio playback system; and the specific operation represents decreasing volume or increasing volume.

10. The method of claim 1, wherein the electronic device is an optical disc player; and the specific operation represents play or stop, or represents switching to a previous track or switching to a next track.

11. An electronic device, comprising:
a controller arranged to provide a user with a remote controller learning service, wherein the controller provides the user with guiding information through a user interface to ask for pressing at least one key of a remote controller of a device, other than the electronic device, wherein the at least one key is utilized for representing a specific operation of the electronic device;
wherein the controller associates the at least one key of the remote controller with the specific operation of the electronic device by storing learning information of the at least one key.

12. The electronic device of claim 11, further comprising:
a remote controller interface module;
wherein the controller receives at least one remote control code from the remote controller through the remote controller interface module when the at least one key is pressed; and the learning information of the at least one key corresponds to the at least one remote control code.

13. The electronic device of claim 12, wherein the at least one key comprises a plurality of keys; and the at least one remote control code comprises a plurality of remote control codes corresponding to the plurality of keys.

14. The electronic device of claim 11, wherein the at least one key comprises a plurality of keys; and the controller associates the plurality of keys of the remote controller with the specific operation of the electronic device by storing the learning information of the plurality of keys.

15. The electronic device of claim 11, wherein the at least one key comprises a plurality of keys; and the controller associates the plurality of keys of the remote controller with the specific operation of the electronic device by storing the learning information of an order of the keys.

16. The electronic device of claim 11, wherein the controller provides the user with a guessing mechanism for guessing which remote controller is used by the user; and the guessing mechanism detects a current status of the electronic device in order to determine which remote controller is a most possible remote controller among others.

17. The electronic device of claim 11, wherein the controller provides the user with a locking mechanism for locking the remote controller or another remote controller as an active remote controller.

18. The electronic device of claim 11, wherein the electronic device is a multi-channel broadcasting program receiver; and the specific operation represents decreasing volume or increasing volume, or represents switching to a previous channel or switching to a next channel.

19. The electronic device of claim 11, wherein the electronic device is an audio playback system; and the specific operation represents decreasing volume or increasing volume.

20. The electronic device of claim 11, wherein the electronic device is an optical disc player; and the specific operation represents play or stop, or represents switching to a previous track or switching to a next track.
